(19) United States
(12) Patent Application Publication
(10) Pub. No.: US 2024/0236717 A9
(43) Pub. Date: Jul. 11, 2024

(54) SYSTEMS AND METHODS FOR DETECTING FIXED WIRELESS ACCESS CUSTOMER PREMISE EQUIPMENT COVERAGE DURING A PLANNED NETWORK OUTAGE

(71) Applicant: Verizon Patent and Licensing Inc., Basking Ridge, NJ (US)

(72) Inventors: Seng GAN, Ashburn, VA (US); Claudio CABETE, Millington, NJ (US); Deep S. SHAH, Bloomfield, NJ (US); Andrew F. PATKA, Holliston, MA (US); Nitheesh Tejaprakash SHETTY, Tampa, FL (US); Ronald CARLONI, Bloomfield, NJ (US)

(73) Assignee: Verizon Patent and Licensing Inc., Basking Ridge, NJ (US)

(21) Appl. No.: 18/048,212

(22) Filed: Oct. 20, 2022

(51) Int. Cl. H04W 24/04; H04L 41/0663; H04L 41/0823

(52) U.S. Cl. CPC H04W 24/04; H04L 41/0663; H04L 41/0823

(57) ABSTRACT

A device may receive a list of 4G base stations and 5G base stations associated with outages and identifiers of FWA CPEs associated with the 4G base stations and the 5G base stations, and may filter identifiers of the FWA CPEs from the list, that fail to satisfy an age out time period, to generate a filtered list. The device may determine whether all 4G base stations are out of service for a particular identifier of remaining identifiers included in the filtered list, and may identify a particular FWA CPE associated with the particular identifier as out of service. The device may determine whether all 5G base stations, associated with operational 4G base stations, are out of service for the particular identifier, and may identify the particular FWA CPE associated with the particular identifier as having only 4G service.

### BACKGROUND

In a fifth-generation (5G) non-standalone (NSA) network, fixed wireless access (FWA) customer premise equipment (CPE) needs to be connected to a fourth-generation (4G) base station (e.g., an eNodeB or eNB) and a 5G base station (e.g., a gNodeB or gNB), and the 5G base station needs to have an anchor relationship with the connected 4G base station in order for the FWA CPE to be connected to the 5G base station.

### BRIEF DESCRIPTION OF THE DRAWINGS

FIGS. 1A-1L are diagrams of an example associated with detecting FWA CPE coverage during a planned network outage.

FIG. 2 is a diagram of an example environment in which systems and/or methods described herein may be implemented.

FIG. 3 is a diagram of example components of one or more devices of FIG. 2.

FIG. 4 is a flowchart of an example process for detecting FWA CPE coverage during a planned network outage.

### DETAILED DESCRIPTION OF EXAMPLE EMBODIMENTS

The following detailed description of example implementations refers to the accompanying drawings. The same reference numbers in different drawings may identify the same or similar elements.

The actual 4G and 5G base stations to which a FWA CPE is connected may diverge widely from predicted 4G and 5G base stations. This presents a problem during a planned outage of 4G and 5G base stations since there is no reliable mechanism to predict which FWA CPEs may be impacted by a planned outage and to predict whether the planned outage only degrades service for a FWA CPE or will put the FWA CPE out of service. Furthermore, the FWA CPE can only connect to a 5G base station with an anchor relationship to a 4G base station, node, and the anchoring relationship may also dynamically change. A connection for an FWA CPE may be permanent when the network service is terminated by a customer or a base station, and the 4G base station/5G base station anchoring is permanent until the anchoring is no longer in use. An FWA CPE tends to stay in one physical location for a very long time, and tends to stay connected to the same 4G and 5G base stations until a network outage occurs. For example, a handover of an FWA CPE may occur due to weather conditions (e.g., rain, sleet, snow, and/or like) or planned maintenance to the 4G and 5G base stations.

Thus, current techniques for predicting 4G and 5G base stations connected to an FWA CPE consume computing resources (e.g., processing resources, memory resources, communication resources, and/or the like), networking resources, and/or other resources associated with disrupting network connectivity for an FWA CPE due to a planned network outage, causing a poor user experience for users of an FWA CPE due to disrupting network connectivity for the FWA CPE, failing to identify disconnected FWA CPEs due to a planned network outage, and/or the like.

Some implementations described herein provide a coverage detection system that detects FWA CPE coverage during network outages (e.g., unplanned or planned network outages). For example, the coverage detection system may receive a list of 4G base stations and 5G base stations associated with outages and identifiers of FWA CPEs associated with the 4G base stations and the 5G base stations, and may filter identifiers of the FWA CPEs from the list that fail to satisfy an age out time period to generate a filtered list. The coverage detection system may determine whether all 4G base stations are out of service for a particular identifier of remaining identifiers included in the filtered list, and may identify a particular FWA CPE associated with the particular identifier as out of service based on determining that all 4G base stations are out of service for the particular identifier. The coverage detection system may determine whether all 5G base stations, associated with operational 4G base stations, are out of service for the particular identifier based on determining that not all 4G base stations are out of service for the particular identifier, and may identify the particular FWA CPE associated with the particular identifier as having only 4G service based on determining that all 5G base stations, associated with operational 4G base stations, are out of service for the particular identifier. The coverage detection system may identify the particular FWA CPE associated with the particular identifier as having 4G and 5G service based on determining that not all 5G base stations, associated with operational 4G base stations, are out of service for the particular identifier.

In this way, the coverage detection system detects FWA CPE coverage during a planned network outage. For example, the coverage detection system may utilize a location of an FWA CPE, a connection history of the FWA CPE, 4G and 5G base station anchoring relationships for the FWA CPE, and/or the like to predict an impact of a planned network outage on the FWA CPE. The coverage detection system may analyze a list of 4G and 5G base stations scheduled for a network outage (e.g., planned or unplanned), and may determine a list of FWA CPEs that will be impacted by the network outage. The coverage detection system may also determine a possible impact of the network outage on an FWA CPE, such as a failover to another 4G base station and another 5G base station with possible degradation of service, a failover to another 4G base station with no 5G connection, a complete loss of service (e.g., no failover possibility), and/or the like. Thus, the coverage detection system may conserve computing resources, networking resources, and/or other resources that would have otherwise been consumed by disrupting network connectivity for an FWA CPE due to a planned network outage, causing a poor user experience for users of an FWA CPE due to disrupting network connectivity for the FWA CPE, failing to identify disconnected FWA CPEs due to a planned network outage, and/or the like.

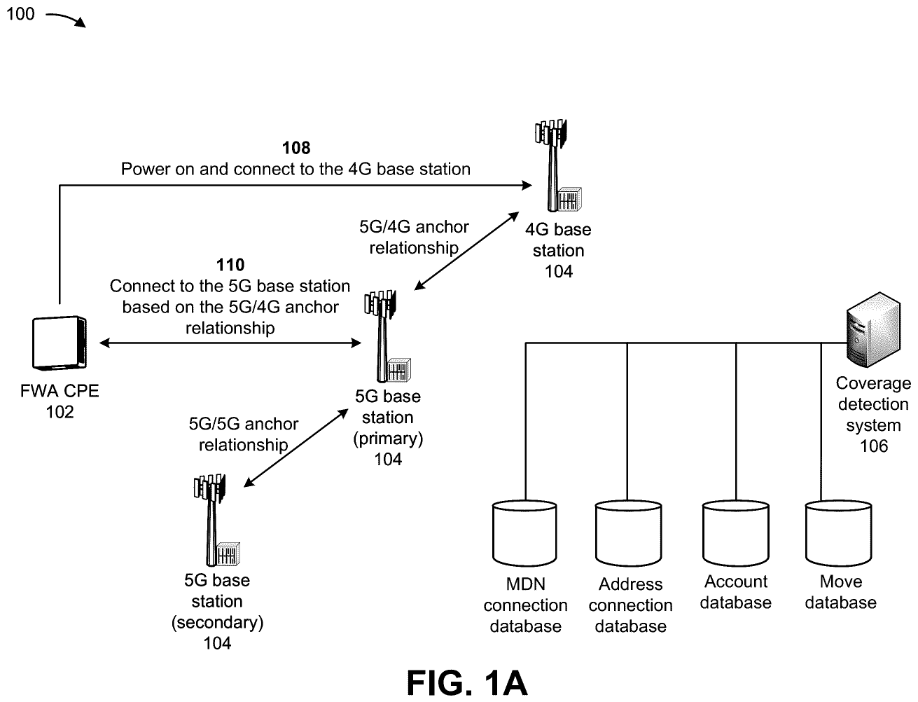

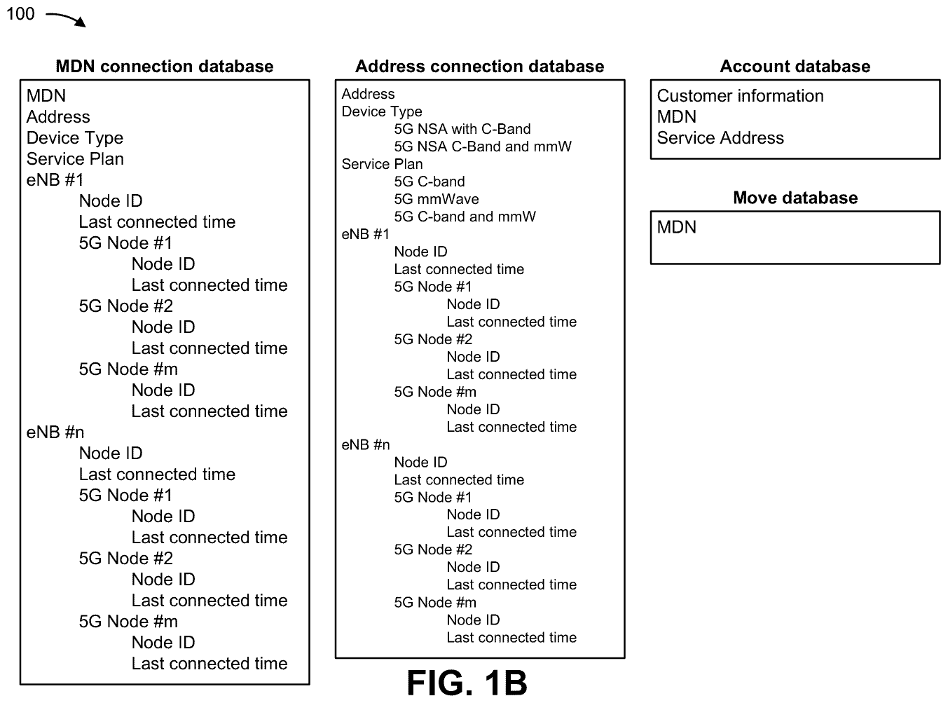

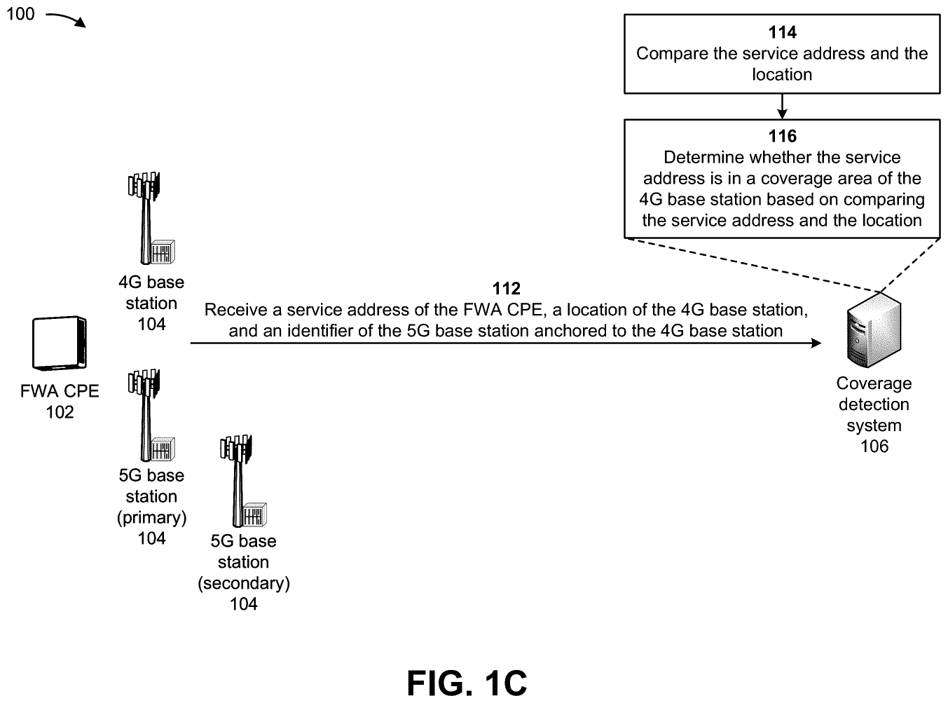

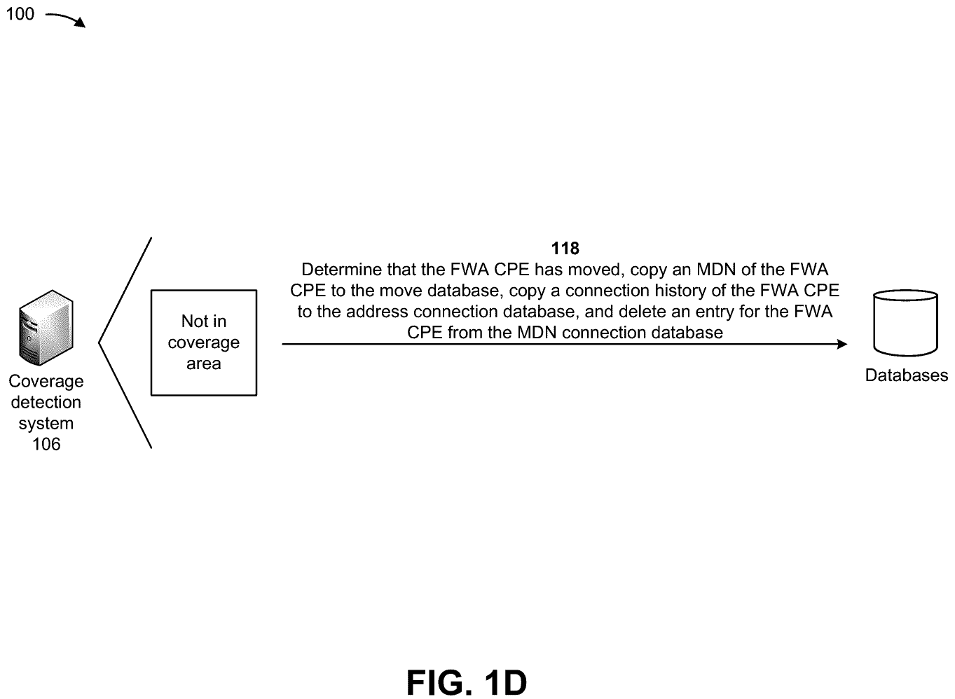

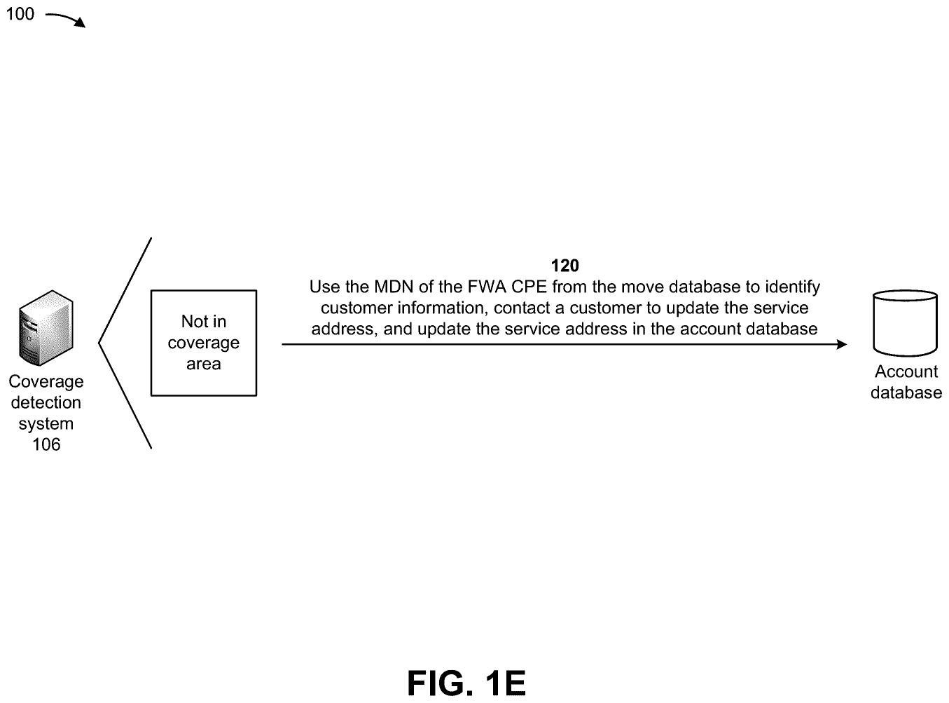

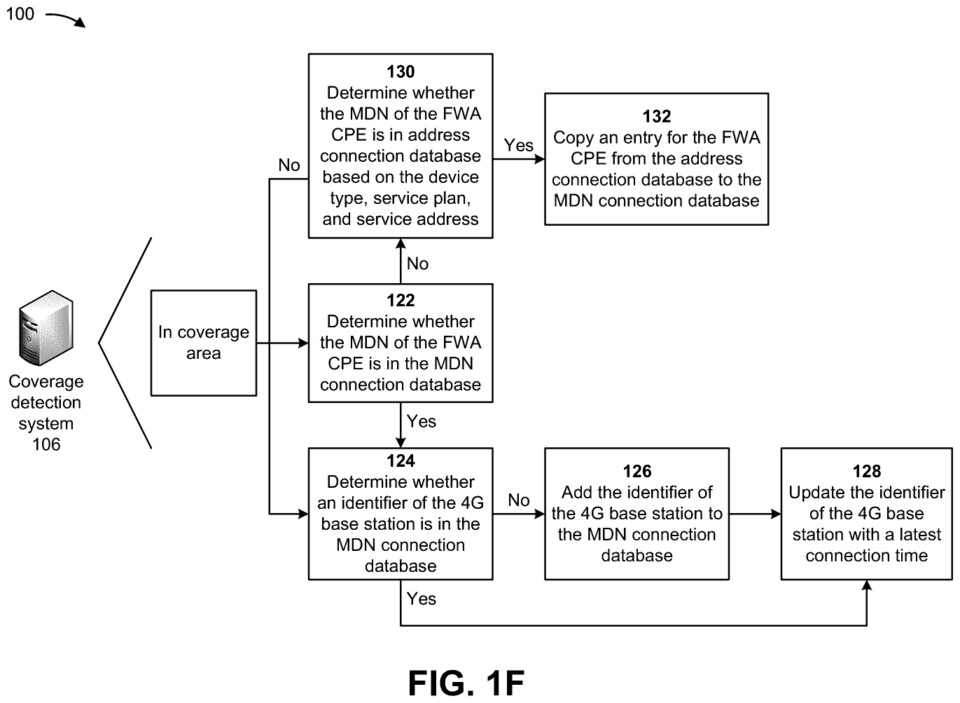

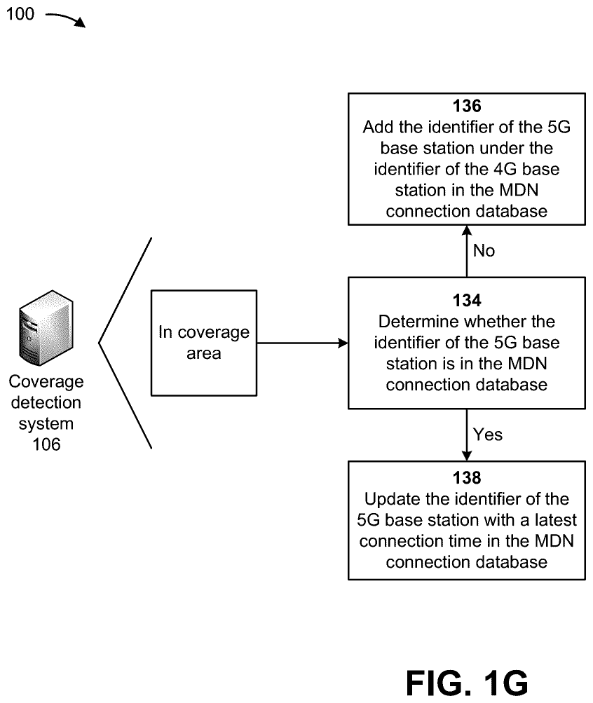

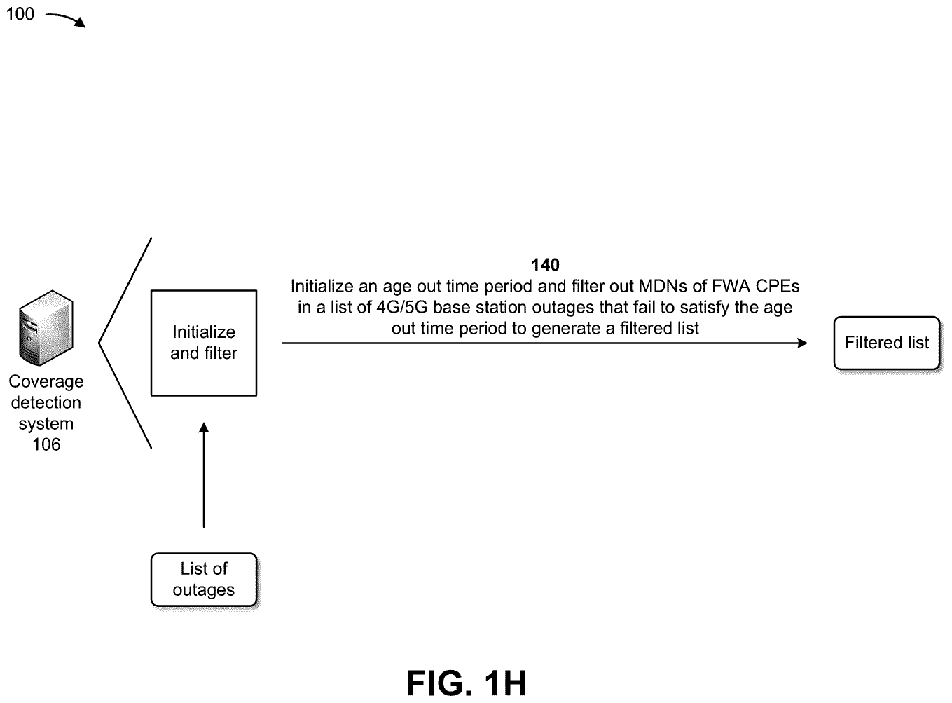

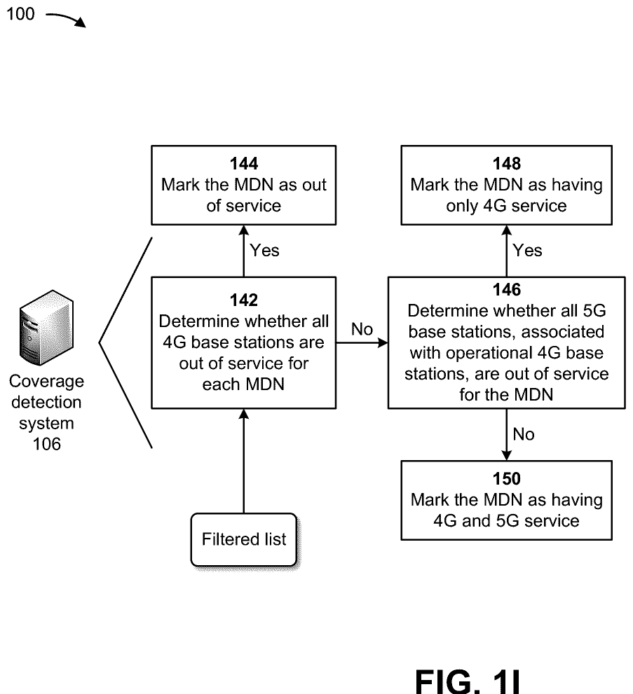

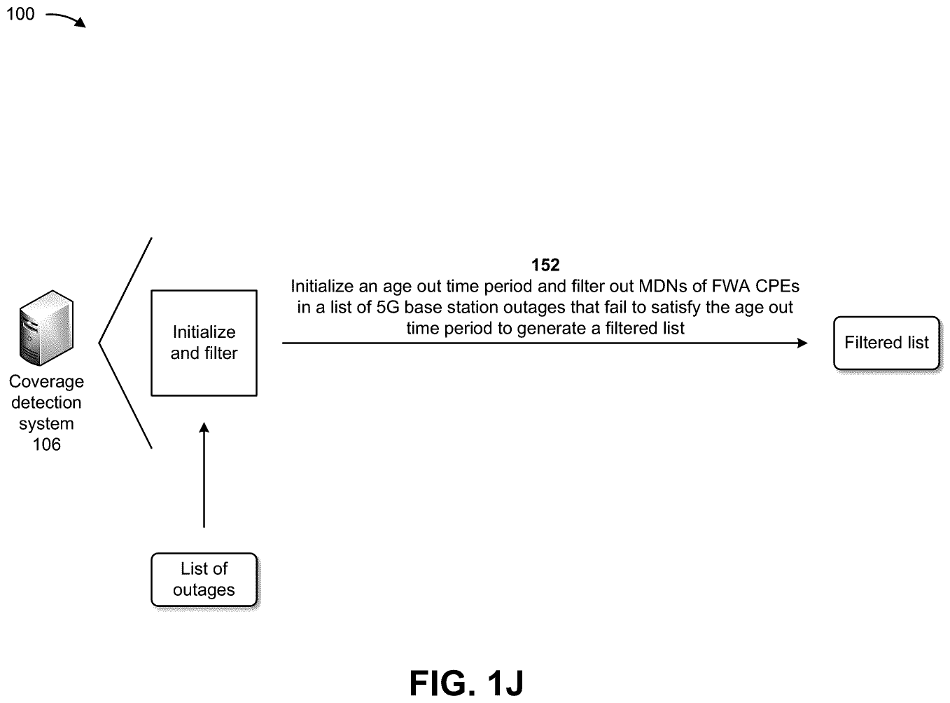

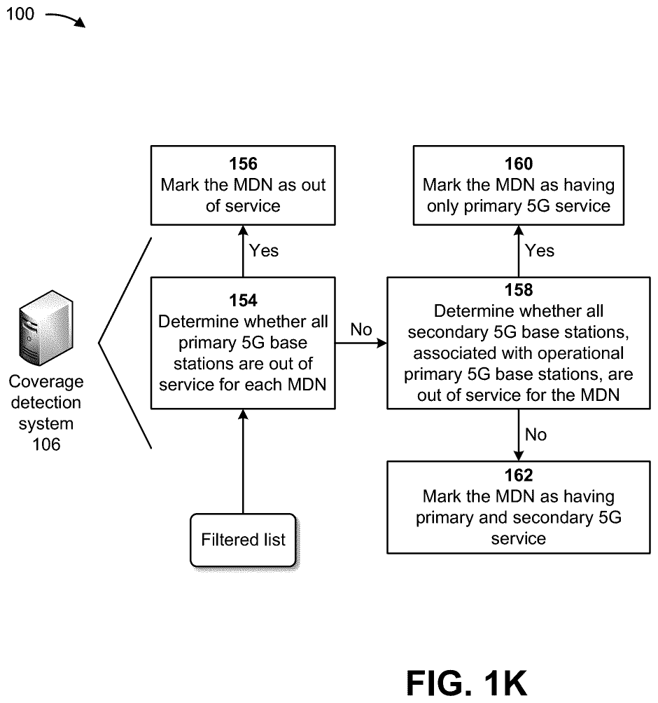

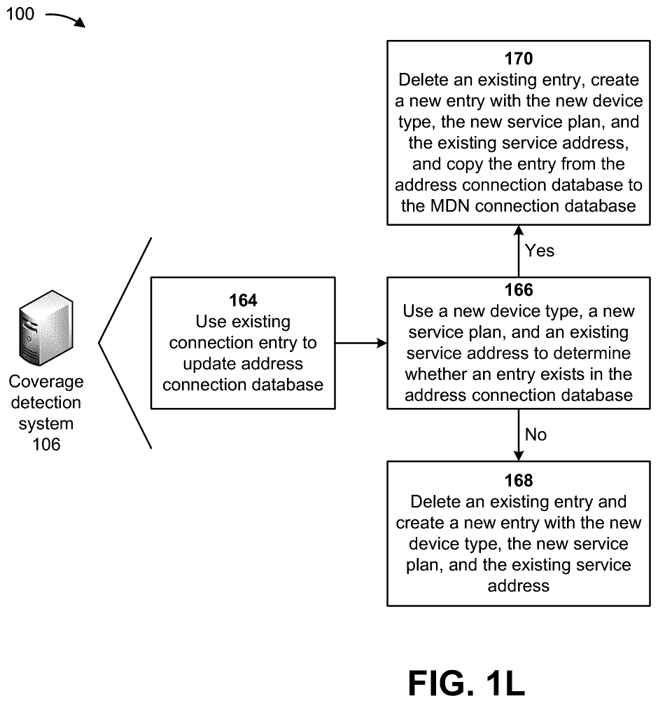

FIGS. 1A-1L are diagrams of an example 100 associated with detecting FWA CPE coverage during a planned network outage. As shown in FIGS. 1A-1L, example 100 includes a FWA CPE 102 associated with a 5G base station 104 (e.g., primary) that includes an anchor relationship with a 4G base station 104 (e.g., in 5G NSA) or a relationship with a secondary 5G base station 104 (e.g., in 5G standalone (SA)). Example 100 also includes a coverage detection system 106 associated with a plurality of data structures (e.g., databases, tables, lists, and/or the like), such as a mobile directory number (MDN) connection database, an address connection database, an account database, and a move database. Further details of the FWA CPE 102, the base stations 104, the coverage detection system 106, the MDN connection database, the address connection database, the account database, and the move database are provided elsewhere herein.

Implementations are described herein in connection with 5G NSA and 5G SA. However, an implementation associated with 5G NSA may be utilized with 5G SA by replacing references to 4G base stations with references to primary 5G base stations and by replacing references to 5G base stations (e.g., anchored to 4G base stations in 5G NSA) with references to secondary 5G base stations (e.g., anchored to primary 5G base stations in 5G SA).

As shown in FIG. 1A, and by reference number 108, the FWA CPE 102 may power on and may connect to the 4G base station 104. For example, in a 5G NSA network, the FWA CPE 102 may connect to the 4G base station when powered on. In a 5G SA network, the FWA CPE 102 may connect to the primary 5G base station 104 when powered on.

As further shown in FIG. 1A, the 4G base station 104 may establish a 5G/4G anchor relationship with the primary 5G base station 104 (e.g., in 5G NSA). Alternatively, the primary 5G base station 104 may establish a 5G/5G anchor relationship with the secondary 5G base station 104 (e.g., in 5G SA). For example, in 5G NSA, the 5G base station 104 may establish an anchor relationship with the connected 4G base station 104 in order for the FWA CPE 102 to be connected to the 5G base station 104. In 5G SA, the primary 5G base station 104 may establish an anchor relationship with the secondary 5G base station 104.

As further shown in FIG. 1A, and by reference number 110, the FWA CPE 102 may connect to the 5G base station 104 based on the 5G/4G anchor relationship. For example, the FWA CPE 102 may connect to the 5G base station 104 after the 5G base station 104 establishes the anchor relationship with the 4G base station 104. The FWA CPE 102 may only see 5G signals from 5G base stations 104 that are anchored to the 4G base station 104 to which the FWA CPE 102 is connected. Alternatively, the FWA CPE 102 may connect to the primary 5G base station 104 and may utilize the secondary 5G base station 104 as needed based on the 5G/5G anchor relationship.

FIG. 1B depicts example data stored in the MDN connection database, the address connection database, the account database, and the move database. As shown, the MDN connection database may include the MDN of the FWA CPE 102, a service address of the FWA CPE 102, a device type associated with the FWA CPE 102, a service plan associated with the FWA CPE 102, and a connection history of the FWA CPE 102. For example, the connection history may indicate that the FWA CPE 102 was connected to a first 4G base station 104 (e.g., eNB #1) with an identifier (e.g., a node ID) at a particular time (e.g., a last connected time); was connected to a first 5G base station 104 (e.g., 5G Node #1), with an identifier (e.g., node ID) and associated with the first 4G base station 104, at a particular time (e.g., a last connected time); was connected to a second 5G base station 104 (e.g., 5G Node #2), with an identifier (e.g., node ID) and associated with the first 4G base station 104, at a particular time (e.g., a last connected time); and was connected to an mth 5G base station 104 (e.g., 5G Node #m), with an identifier (e.g., node ID) and associated with the first 4G base station 104, at a particular time (e.g., a last connected time).

The connection history of the MDN connection database may indicate that the FWA CPE 102 was connected to an nth 4G base station 104 (e.g., eNB #n) with an identifier (e.g., a node ID) at a particular time (e.g., a last connected time); was connected to the first 5G base station 104 (e.g., 5G Node #1), with an identifier (e.g., node ID) and associated with the second 4G base station 104, at a particular time (e.g., a last connected time); was connected to the second 5G base station 104 (e.g., 5G Node #2), with an identifier (e.g., node ID) and associated with the second 4G base station 104, at a particular time (e.g., a last connected time); and was connected to the mth 5G base station 104 (e.g., 5G Node #m), with an identifier (e.g., node ID) and associated with the second 4G base station 104, at a particular time (e.g., a last connected time).

As further shown in FIG. 1B, the address connection database may include the service address of the FWA CPE 102, a device type associated with the FWA CPE 102 (e.g., 5G NSA with C-Band and 5G NSA C-Band and millimeter wave (mmW)), a service plan associated with the FWA CPE 102, and a connection history of the FWA CPE 102. For example, the connection history of the FWA CPE 102 may be similar to the connection history of the MDN connection database, described above.

As further shown in FIG. 1B, the account database may include customer information for a customer that utilizes the FWA CPE 102, the MDN of the FWA CPE 102, and the service address of the FWA CPE 102. The move database may include the MDN of the FWA CPE 102. In some implementations, the databases depicted in FIG. 1B may include more data, fewer data, different data, and/or the like than shown in FIG. 1B.

As shown in FIG. 1C, and by reference number 112, the coverage detection system 106 may receive a service address of the FWA CPE 102, a location of the 4G base station 104, and an identifier of the 5G base station 104 anchored to the 4G base station 104. For example, the coverage detection system 106 may receive the service address of the FWA CPE 102 from the MDN connection database, and may receive the location of the 4G base station 104 from the 4G base station 104 and/or from the MDN connection database. The coverage detection system 106 may receive the identifier (e.g., node ID) of the 5G base station 104, anchored to the 4G base station 104, from the 5G base station 104 and/or from the MDN connection database.

As further shown in FIG. 1C, and by reference number 114, the coverage detection system 106 may compare the service address and the location. For example, the coverage detection system 106 may compare the service address of the FWA CPE 102 and the location of the 4G base station 104. In some implementations, the coverage detection system 106 may compare the service address of the FWA CPE 102 and a coverage area of the 4G base station 104 based on the location of the 4G base station 104. The coverage area of the 4G base station 104 may include the geographic location of the 4G base station 104 and a geographic area capable of receiving a signal from the 4G base station 104.

As further shown in FIG. 1C, and by reference number 116, the coverage detection system 106 may determine whether the service address is in a coverage area of the 4G base station 104 based on comparing the service address and the location. For example, the coverage detection system 106 may determine whether the service address of the FWA CPE 102 is in the coverage area of the 4G base station 104 based on comparing the service address of the FWA CPE 102 and the location of the 4G base station 104. In some implementations, the coverage detection system 106 may determine that the service address of the FWA CPE 102 is not in the coverage area of the 4G base station 104 when the service address is not within the geographic area capable of receiving the signal from the 4G base station 104. Alternatively, the coverage detection system 106 may determine that the service address of the FWA CPE 102 is in the coverage area of the 4G base station 104 when the service address is within the geographic area capable of receiving the signal from the 4G base station 104.

As shown in FIG. 1D, and by reference number 118, the coverage detection system 106 may determine that the FWA CPE 102 has moved, may copy an MDN of the FWA CPE 102 to the move database, may copy a connection history of the FWA CPE 102 to the address connection database, and may delete an entry for the FWA CPE 102 from the MDN connection database based on the service address not being in the coverage area of the 4G base station 104. For example, if the coverage detection system 106 determines that the service address of the FWA CPE 102 is not in the coverage area of the 4G base station 104, the coverage detection system 106 may determine that the FWA CPE 102 has moved away from the service address included in the MDN connection database. Accordingly, the coverage detection system 106 may copy the MDN of the FWA CPE 102 to the move database (e.g., to indicate that the FWA CPE 102 has moved from the service address), and may copy the connection history of the FWA CPE 102 from the MDN connection database to the address connection database. The coverage detection system 106 may also delete the entry for the FWA CPE 102 from the MDN connection database.

As shown in FIG. 1E, and by reference number 120, the coverage detection system 106 may use the MDN of the FWA CPE 102 from the move database to identify customer information, may contact a customer to update the service address, and may update the service address in the account database based on the service address not being in the coverage area of the 4G base station 104. For example, if the coverage detection system 106 determines that the service address of the FWA CPE 102 is not in the coverage area of the 4G base station 104, the coverage detection system 106 may utilize the MDN of the FWA CPE 102 copied from the MDN connection database to the move database to identify customer information in the move database associated with a customer utilizing the FWA CPE 102. The coverage detection system 106 may contact the customer (e.g., or cause the customer to be contacted) to receive an updated service address for the FWA CPE 102, and may replace the service address in the account database with the updated service address for the FWA CPE 102.

As shown in FIG. 1F, and by reference number 122, the coverage detection system 106 may determine whether the MDN of the FWA CPE 102 is in the MDN connection database based on the service address being in the coverage area of the 4G base station 104. For example, if the coverage detection system 106 determines that the service address of the FWA CPE 102 is in the coverage area of the 4G base station 104, the coverage detection system 106 may determine whether the MDN of the FWA CPE 102 is in the MDN connection database. In some implementations, the coverage detection system 106 may determine that the MDN of the FWA CPE 102 is in the MDN connection database. Alternatively, the coverage detection system 106 may determine that the MDN of the FWA CPE 102 is not in the MDN connection database.

As further shown in FIG. 1F, and by reference number 124, the coverage detection system 106 may determine whether an identifier of the 4G base station 104 is in the MDN connection database based on determining that the MDN of the FWA CPE 102 is in the MDN connection database. For example, if the coverage detection system 106 determines that the MDN of the FWA CPE 102 is in the MDN connection database, the coverage detection system 106 may determine whether the identifier of the 4G base station 104 is in the MDN connection database. In some implementations, the coverage detection system 106 may determine that the identifier of the 4G base station 104 is in the MDN connection database. Alternatively, the coverage detection system 106 may determine that the identifier of the 4G base station 104 is not in the MDN connection database.

As further shown in FIG. 1F, and by reference number 126, the coverage detection system 106 may add the identifier of the 4G base station 104 to the MDN connection database based on determining that the identifier of the 4G base station 104 is not in the MDN connection database. For example, if the coverage detection system 106 determines that the identifier of the 4G base station 104 is not in the MDN connection database, the coverage detection system 106 may add the identifier (e.g., the Node ID) of the 4G base station 104 to the MDN connection database.

As further shown in FIG. 1F, and by reference number 128, the coverage detection system 106 may update the identifier of the 4G base station 104 with a latest connection time. For example, if the coverage detection system 106 determines that the identifier of the 4G base station 104 is not in the MDN connection database, the coverage detection system 106 may update (e.g., in the MDN connection database) the identifier (e.g., the Node ID) of the 4G base station 104 with a latest connection time of the FWA CPE 102 and the 4G base station 104.

As further shown in FIG. 1F, and by reference number 130, the coverage detection system 106 may determine whether the MDN of the FWA CPE 102 is in the address connection database based on determining that the MDN of the FWA CPE 102 is not in the MDN connection database. For example, if the coverage detection system 106 determines that the identifier of the 4G base station 104 is in the MDN connection database, the coverage detection system 106 may utilize the MDN, a device type, a service plan, and the service address of the FWA CPE 102 to determine whether the MDN of the FWA CPE 102 is in the address connection database. In some implementations, the coverage detection system 106 may determine that the MDN of the FWA CPE 102 is in the address connection database. Alternatively, the coverage detection system 106 may determine that the MDN of the FWA CPE 102 is not in the address connection database.

As further shown in FIG. 1F, and by reference number 132, the coverage detection system 106 may copy an entry for the FWA CPE 102 from the address connection database to the MDN connection database based on determining that the MDN of the FWA CPE 102 is in the address connection database. For example, if the coverage detection system 106 determines that the MDN of the FWA CPE 102 is in the address connection database, the coverage detection system 106 may copy the entry (e.g., with the device type, the service plan, and the service address of the FWA CPE 102) for the FWA CPE 102 from the address connection database to the MDN connection database.

As further shown in FIG. 1F, the coverage detection system 106 may perform reference number 124 based on determining that the MDN of the FWA CPE 102 is not in the address connection database. For example, if the coverage detection system 106 determines that the MDN of the FWA CPE 102 is not in the address connection database, the coverage detection system 106 may determine whether the identifier of the 4G base station 104 is in the MDN connection database.

As shown in FIG. 1G, and by reference number 134, the coverage detection system 106 may determine whether the identifier of the 5G base station 104 is in the MDN connection database. For example, the coverage detection system 106 may determine whether the identifier of the 5G base station 104 (e.g., anchored to the 4G base station 104) is provided under the entry for the 4G base station 104 in the MDN connection database. In some implementations, the coverage detection system 106 may determine that the identifier of the 5G base station 104 is in the MDN connection database (e.g., when the identifier of the 5G base station 104 is provided under the entry for the 4G base station 104 in the MDN connection database). Alternatively, the coverage detection system 106 may determine that the identifier of the 5G base station 104 is not in the MDN connection database (e.g., when the identifier of the 5G base station 104 is not provided under the entry for the 4G base station 104 in the MDN connection database).

As further shown in FIG. 1G, and by reference number 136, the coverage detection system 106 may add the identifier of the 5G base station 104 under the identifier of the 4G base station 104 in the MDN connection database based on determining that the identifier of the 5G base station 104 is not in the MDN connection database. For example, if the coverage detection system 106 determines that the identifier of the 5G base station 104 is not in the MDN connection database, the coverage detection system 106 may add the identifier of the 5G base station 104 under the identifier of the 4G base station 104 (e.g., the entry for the 4G base station 104) in the MDN connection database.

As further shown in FIG. 1G, and by reference number 138, the coverage detection system 106 may update the identifier of the 5G base station 104 with a latest connection time in the MDN connection database based on determining that the identifier of the 5G base station 104 is in the MDN connection database. For example, if the coverage detection system 106 determines that the identifier of the 5G base station 104 is in the MDN connection database, the coverage detection system 106 may update (e.g., in the MDN connection database) the identifier (e.g., the Node ID) of the 5G base station 104 with a latest connection time of the FWA CPE 102 and the 5G base station 104.

As shown in FIG. 1H, and by reference number 140, the coverage detection system 106 may initialize an age out time period and may filter out MDNs of FWA CPEs 102 in a list of 4G and 5G base station 104 outages that fail to satisfy the age out time period to generate a filtered list. For example, the coverage detection system 106 may determine how planned outages of 4G and 5G base stations 104 may affect service for FWA CPEs 102. The coverage detection system 106 may utilize the age out time period (e.g., two months, three months, and/or the like) in order to filter out FWA CPEs 102 with last connected times greater than the age out time period. The coverage detection system 106 may receive the list of the 4G and 5G base stations 104 associated with the planned outages (e.g., and MDNs of FWA CPEs 102 associated with the 4G and 5G base stations 104), and may filter out MDNs of FWA CPEs 102, from the list of 4G and 5G base station 104 outages that fail to satisfy the age out time period, to generate the filtered list. The filtered list may include identifiers of the 4G and 5G base stations 104 associated with the planned outages and non-filtered out MDNs of the FWA CPEs 102 associated with the 4G and 5G base stations 104.

As shown in FIG. 1I, and by reference number 142, the coverage detection system 106 may determine whether all 4G base stations 104 are out of service for each MDN of the filtered list. For example, the coverage detection system 106 may determine whether all 4G base stations 104 included in the filtered list will be out of service for each of the non-filtered out MDNs of the FWA CPEs 102 associated with the 4G base stations 104 in the filtered list. In some implementations, the coverage detection system 106 may determine that all 4G base stations 104 included in the filtered list will be out of service for each of the non-filtered out MDNs of the FWA CPEs 102 associated with the 4G base stations 104 in the filtered list. Alternatively, the coverage detection system 106 may determine that all 4G base stations 104 included in the filtered list will not be out of service for each of the non-filtered out MDNs of the FWA CPEs 102 associated with the 4G base stations 104 in the filtered list.

As further shown in FIG. 1I, and by reference number 144, the coverage detection system 106 may mark the MDN as out of service based on determining that all 4G base stations 104 are out of service for the MDN. For example, if the coverage detection system 106 determines that all 4G base stations 104 included in the filtered list will be out of service for an MDN of an FWA CPE 102, the coverage detection system 106 may mark the MDN as out of service in the filtered list.

As further shown in FIG. 1I, and by reference number 146, the coverage detection system 106 may determine whether all 5G base stations 104, associated with operational 4G base stations 104, are out of service for the MDN based on determining that not all 4G base stations 104 are out of service for the MDN. For example, if the coverage detection system 106 determines that not all 4G base stations 104 included in the filtered list will be out of service for the MDN of the FWA CPE 102, the coverage detection system 106 may determine whether all 5G base stations 104, associated with operational 4G base stations 104, are out of service for the MDN of the FWA CPE 102. In some implementations, the coverage detection system 106 may determine that all 5G base stations 104, associated with operational 4G base stations 104, are out of service for the MDN of the FWA CPE 102. Alternatively, the coverage detection system 106 may determine that not all 5G base stations 104, associated with operational 4G base stations 104, are out of service for the MDN of the FWA CPE 102.

As further shown in FIG. 1I, and by reference number 148, the coverage detection system 106 may mark the MDN as having only 4G service based on determining that all 5G base stations 104, associated with operational 4G base stations 104, are out of service for the MDN. For example, if the coverage detection system 106 determines that all 5G base stations 104, associated with operational 4G base stations 104, are out of service for the MDN of the FWA CPE 102, the coverage detection system 106 may mark the MDN as having only 4G service in the filtered list.

As further shown in FIG. 1I, and by reference number 150, the coverage detection system 106 may mark the MDN as having 4G and 5G service based on determining that not all 5G base stations 104, associated with operational 4G base stations 104, are out of service for the MDN. For example, if the coverage detection system 106 determines that not all 5G base stations 104, associated with operational 4G base stations 104, are out of service for the MDN of the FWA CPE 102, the coverage detection system 106 may mark the MDN as having 4G and 5G service in the filtered list.

As shown in FIG. 1J, and by reference number 152, the coverage detection system 106 may initialize an age out time period and may filter out MDNs of FWA CPEs 102 in a list of 5G base station 104 outages that fail to satisfy the age out time period to generate a filtered list. For example, the coverage detection system 106 may determine how planned outages of 5G base stations 104 may affect service for FWA CPEs 102 (e.g., in 5G SA). The coverage detection system 106 may utilize the age out time period (e.g., two months, three months, and/or the like) in order to filter out FWA CPEs 102 with last connected times greater than the age out time period. The coverage detection system 106 may receive the list of the primary and secondary 5G base stations 104 associated with the planned outages (e.g., and MDNs of FWA CPEs 102 associated with the primary and secondary 5G base stations 104), and may filter out MDNs of FWA CPEs 102, from the list of 5G base station 104 outages that fail to satisfy the age out time period, to generate the filtered list. The filtered list may include identifiers of the primary and secondary 5G base stations 104 associated with the planned outages and non-filtered out MDNs of the FWA CPEs 102 associated with the primary and secondary 5G base stations 104.

As shown in FIG. 1K, and by reference number 154, the coverage detection system 106 may determine whether all primary 5G base stations 104 are out of service for each MDN of the filtered list. For example, the coverage detection system 106 may determine whether all primary 5G base stations 104 included in the filtered list will be out of service for each of the non-filtered out MDNs of the FWA CPEs 102 associated with the primary 5G base stations 104 in the filtered list. In some implementations, the coverage detection system 106 may determine that all primary 5G base stations 104 included in the filtered list will be out of service for each of the non-filtered out MDNs of the FWA CPEs 102 associated with the primary 5G base stations 104 in the filtered list. Alternatively, the coverage detection system 106 may determine that all primary 5G base stations 104 included in the filtered list will not be out of service for each of the non-filtered out MDNs of the FWA CPEs 102 associated with the primary 5G base stations 104 in the filtered list.

As further shown in FIG. 1K, and by reference number 156, the coverage detection system 106 may mark the MDN as out of service based on determining that all primary 5G base stations 104 are out of service for the MDN. For example, if the coverage detection system 106 determines that all primary 5G base stations 104 included in the filtered list will be out of service for an MDN of an FWA CPE 102, the coverage detection system 106 may mark the MDN as out of service in the filtered list.

As further shown in FIG. 1K, and by reference number 158, the coverage detection system 106 may determine whether all secondary 5G base stations 104, associated with operational primary 5G base stations 104, are out of service for the MDN based on determining that not all primary 5G base stations 104 are out of service for the MDN. For example, if the coverage detection system 106 determines that not all primary 5G base stations 104 included in the filtered list will be out of service for the MDN of the FWA CPE 102, the coverage detection system 106 may determine whether all secondary 5G base stations 104, associated with operational primary 5G base stations 104, are out of service for the MDN of the FWA CPE 102. In some implementations, the coverage detection system 106 may determine that all secondary 5G base stations 104, associated with operational primary 5G base stations 104, are out of service for the MDN of the FWA CPE 102. Alternatively, the coverage detection system 106 may determine that not all secondary 5G base stations 104, associated with operational primary 5G base stations 104, are out of service for the MDN of the FWA CPE 102.

As further shown in FIG. 1K, and by reference number 160, the coverage detection system 106 may mark the MDN as having only primary 5G service based on determining that all secondary 5G base stations 104, associated with operational primary 5G base stations 104, are out of service for the MDN. For example, if the coverage detection system 106 determines that all secondary 5G base stations 104, associated with operational primary 5G base stations 104, are out of service for the MDN of the FWA CPE 102, the coverage detection system 106 may mark the MDN as having only primary 5G service in the filtered list.

As further shown in FIG. 1K, and by reference number 162, the coverage detection system 106 may mark the MDN as having primary and secondary 5G service based on determining that not all secondary 5G base stations 104, associated with operational primary 5G base stations 104, are out of service for the MDN. For example, if the coverage detection system 106 determines that not all secondary 5G base stations 104, associated with operational primary 5G base stations 104, are out of service for the MDN of the FWA CPE 102, the coverage detection system 106 may mark the MDN as having primary and secondary 5G service in the filtered list.

In a 5G NSA example, 4G base stations A, B, and C may be out of service, 5G base stations D, E, and F may be out of service, the age out time period may be three months, and all connection times associated with an MDN of an FWA CPE 102 may be less than 3 months. An MDN connection record associated with the FWA CPE 102 may indicate that the FWA CPE 102 was connected to 4G base station G and 5G base station H. In such an example, the coverage detection system 106 may determine that since 4G base station G and 5G base station H are not impacted by an outage, the FWA CPE 102 may continue to receive 4G service and 5G service.

In another 5G NSA example, 4G base stations A, B, and C may be out of service, 5G base stations D, E, and F may be out of service, the age out time period may be three months, and all connection times associated with an MDN of an FWA CPE 102 may be less than 3 months. An MDN connection record associated with the FWA CPE 102 indicates that the FWA CPE 102 was connected to 4G base station A and 5G base station H. In such an example, the coverage detection system 106 may determine that since 4G base station A is out of service, the FWA CPE 102 may not connect to 5G base station H and may not receive 4G service and 5G service.

In another 5G NSA example, 4G base stations A, B, and C may be out of service, 5G base stations D, E, and F may be out of service, the age out time period may be three months, and all connection times associated with an MDN of an FWA CPE 102 may be less than 3 months. An MDN connection record associated with the FWA CPE 102 indicates that the FWA CPE 102 was connected to 4G base station G and 5G base station D. In such an example, the coverage detection system 106 may determine that since the FWA CPE 102 may connect to 4G base station G and that 5G base station D is out of service, the FWA CPE 102 may only receive 4G service.

In another 5G NSA example, 4G base stations A, B, and C may be out of service, 5G base stations D, E, and F may be out of service, the age out time period may be three months, and all connection times associated with an MDN of an FWA CPE 102 may be less than 3 months. An MDN connection record associated with the FWA CPE 102 indicates that the FWA CPE 102 was connected to 4G base station A and 5G base station D, 4G base station H and 5G base station E, and 4G base station I and 5G base station J. In such an example, the coverage detection system 106 may determine that the FWA CPE 102 may connect to 4G base stations H and I, and that the 4G base station I and 5G base station J pair can provide both 4G service and 5G service to FWA CPE 102.

In another 5G NSA example, 4G base stations A, B, and C may be out of service, 5G base stations D, E, and F may be out of service, the age out time period may be three months, and all connection times associated with an MDN of an FWA CPE 102 may be less than 3 months. An MDN connection record associated with the FWA CPE 102 indicates that the FWA CPE 102 was connected to 4G base station A and 5G base station D and to 4G base station I. In such an example, the coverage detection system 106 may determine that the FWA CPE 102 may connect to 4G base station I but that 4G base station I has no anchor relationship with any 5G base station. Thus, the coverage detection system 106 may determine that the FWA CPE 102 may only receive 4G service.

In a 5G SA example, primary 5G base stations A, B, and C may be out of service, secondary 5G base stations D, E, and F may be out of service, the age out time period may be three months, and all connection times associated with an MDN of an FWA CPE 102 may be less than 3 months. An MDN connection record associated with the FWA CPE 102 may indicate that the FWA CPE 102 was connected to primary 5G base station G and secondary 5G base station H. In such an example, the coverage detection system 106 may determine that since primary 5G base station G and secondary 5G base station H are not impacted by an outage, the FWA CPE 102 may continue to receive 5G service from primary 5G base station G and secondary 5G base station H.

In another 5G SA example, primary 5G base stations A, B, and C may be out of service, secondary 5G base stations D, E, and F may be out of service, the age out time period may be three months, and all connection times associated with an MDN of an FWA CPE 102 may be less than 3 months. An MDN connection record associated with the FWA CPE 102 may indicate that the FWA CPE 102 was connected to primary 5G base station A and secondary 5G base station H. In such an example, the coverage detection system 106 may determine that since primary 5G base station A is out of service, the FWA CPE 102 may not connect to secondary 5G base station H and may not receive 5G service from primary 5G base station A and secondary 5G base station H.

In another 5G SA example, primary 5G base stations A, B, and C may be out of service, secondary 5G base stations D, E, and F may be out of service, the age out time period may be three months, and all connection times associated with an MDN of an FWA CPE 102 may be less than 3 months. An MDN connection record associated with the FWA CPE 102 may indicate that the FWA CPE 102 was connected to primary 5G base station G and secondary 5G base station D. In such an example, the coverage detection system 106 may determine that since the FWA CPE 102 may connect to primary 5G base station G and that secondary 5G base station D is out of service, the FWA CPE 102 may only receive 5G service from primary 5G base station.

In another 5G SA example, primary 5G base stations A, B, and C may be out of service, secondary 5G base stations D, E, and F may be out of service, the age out time period may be three months, and all connection times associated with an MDN of an FWA CPE 102 may be less than 3 months. An MDN connection record associated with the FWA CPE 102 may indicate that the FWA CPE 102 was connected to primary 5G base station A and secondary 5G base station D, primary 5G base station H and secondary 5G base station E, and primary 5G base station I and secondary 5G base station J. In such an example, the coverage detection system 106 may determine that the FWA CPE 102 may connect to primary 5G base stations H and I, and that the primary 5G base station I and secondary 5G base station J pair can provide both primary and secondary 5G service to FWA CPE 102.

In another 5G SA example, primary 5G base stations A, B, and C may be out of service, secondary 5G base stations D, E, and F may be out of service, the age out time period may be three months, and all connection times associated with an MDN of an FWA CPE 102 may be less than 3 months. An MDN connection record associated with the FWA CPE 102 may indicate that the FWA CPE 102 was connected to primary 5G base station A and secondary 5G base station D and to primary 5G base station I. In such an example, the coverage detection system 106 may determine that the FWA CPE 102 may connect to primary 5G base station I but that primary 5G base station I has no secondary 5G base station. Thus, the coverage detection system 106 may determine that the FWA CPE 102 may only receive primary 5G service from primary 5G base station I.

FIG. 1L depicts functions performed by the coverage detection system 106 to update the MDN connection database when a device type and a service plan change. As shown in FIG. 1L, and by reference number 164, the coverage detection system 106 may use an existing connection entry to update the address connection database. As shown by reference number 166, the coverage detection system 106 may use a new device type, a new service plan, and an existing service address to determine whether an entry exists in the address connection database. As shown by reference number 168, when the coverage detection system 106 determines that an entry does not exist in the address connection database, the coverage detection system 106 may delete an existing entry and may create a new entry with the new device type, the new service plan, and the existing service address in the address connection database. As shown by reference number 170, when the coverage detection system 106 determines that an entry exists in the address connection database, the coverage detection system 106 may delete an existing entry, may create a new entry with the new device type, the new service plan, and the existing service address, and may copy the entry from the address connection database to the MDN connection database.

In this way, the coverage detection system 106 detects FWA CPE 102 coverage during a planned network outage. For example, the coverage detection system 106 may utilize a location of an FWA CPE 102, a connection history of the FWA CPE 102, 4G and 5G base stations 104 anchoring relationships for the FWA CPE 102, and/or the like to predict an impact of a planned network outage on the FWA CPE 102. The coverage detection system 106 may analyze a list of 4G and 5G base stations 104 scheduled for a network outage (e.g., planned or unplanned), and may determine a list of FWA CPEs 102 that will be impacted by the network outage. The coverage detection system 106 may also determine a possible impact of the network outage on an FWA CPE 102, such as a failover to another 4G base station 104 and another 5G base station 104 with possible degradation of service, a failover to another 4G base station 104 with no 5G connection, a complete loss of service (e.g., no failover possibility), and/or the like. Thus, the coverage detection system 106 may conserve computing resources, networking resources, and/or other resources that would have otherwise been consumed by disrupting network connectivity for an FWA CPE 102 due to a planned network outage, causing a poor user experience for users of an FWA CPE 102 due to disrupting network connectivity for the FWA CPE 102, failing to identify disconnected FWA CPEs 102 due to a planned network outage, and/or the like.

As indicated above, FIGS. 1A-1L are provided as an example. Other examples may differ from what is described with regard to FIGS. 1A-1L. The number and arrangement of devices shown in FIGS. 1A-1L are provided as an example. In practice, there may be additional devices, fewer devices, different devices, or differently arranged devices than those shown in FIGS. 1A-1L. Furthermore, two or more devices shown in FIGS. 1A-1L may be implemented within a single device, or a single device shown in FIGS. 1A-1L may be implemented as multiple, distributed devices. Additionally, or alternatively, a set of devices (e.g., one or more devices) shown in FIGS. 1A-1L may perform one or more functions described as being performed by another set of devices shown in FIGS. 1A-1L.

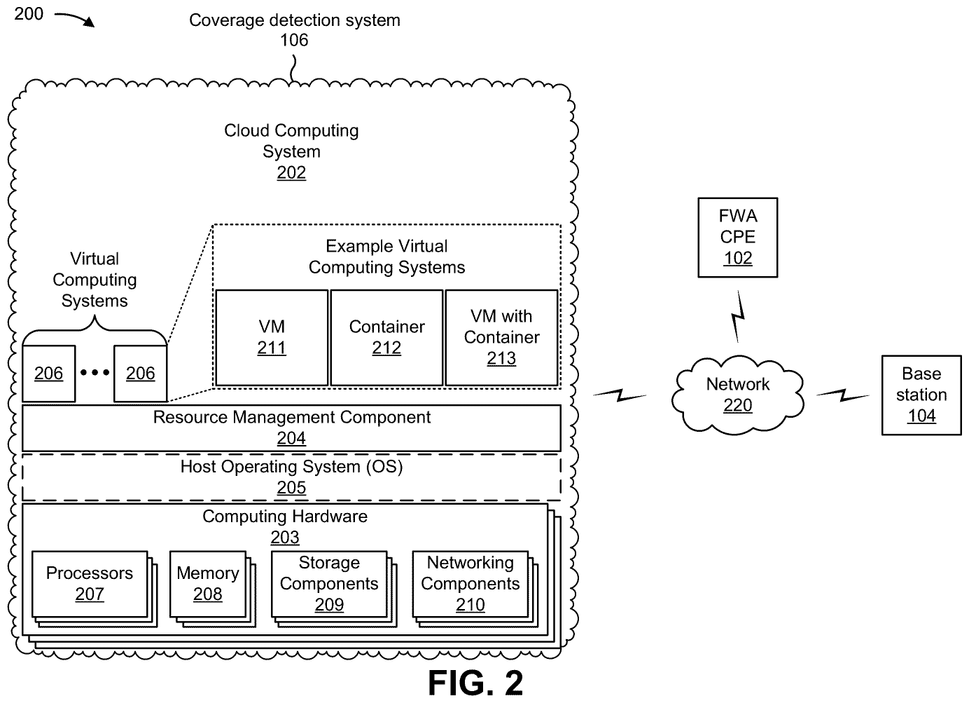

FIG. 2 is a diagram of an example environment 200 in which systems and/or methods described herein may be implemented. As shown in FIG. 2, the environment 200 may include the coverage detection system 106, which may include one or more elements of and/or may execute within a cloud computing system 202. The cloud computing system 202 may include one or more elements 203-213, as described in more detail below. As further shown in FIG. 2, the environment 200 may include the FWA CPE 102, the base station 104, and/or a network 220. Devices and/or elements of the environment 200 may interconnect via wired connections and/or wireless connections.

The FWA CPE 102 includes one or more devices capable of receiving, generating, storing, processing, and/or providing information, such as information described herein. For example, the FWA CPE 102 may include a mobile hotspot device, an FWA device, a CPE, an FWA channel service unit, an FWA data service unit, an FWA router, an FWA wireless access point (WAP) device, an FWA modem, a FWA set-top box, or a similar type of device. The FWA CPE may provide wireless connectivity through radio links between two fixed points. In other words, the FWA CPE may provide wireless Internet access to homes or businesses without laying fiber and cables to provide last mile connectivity.

The base station 104 includes one or more devices capable of transferring traffic, such as audio, video, text, and/or other traffic, destined for and/or received from a user equipment (UE). For example, the base station 104 may include an eNodeB (eNB) associated with a long term evolution (LTE) network that receives traffic from and/or sends traffic to a core network, a gNodeB (gNB) associated with a RAN of a 5G network, a base transceiver station, a radio base station, a base station subsystem, a cellular site, a cellular tower, an access point, a transmit receive point (TRP), a radio access node, a macrocell base station, a microcell base station, a picocell base station, a femtocell base station, and/or another network entity capable of supporting wireless communication. The base station 104 may support, for example, a cellular radio access technology (RAT). The base station 104 may transfer traffic between a FWA CPE (e.g., using a cellular RAT), one or more other base stations 104 (e.g., using a wireless interface or a backhaul interface, such as a wired backhaul interface), and/or a core network. The base station 104 may provide one or more cells that cover geographic areas.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

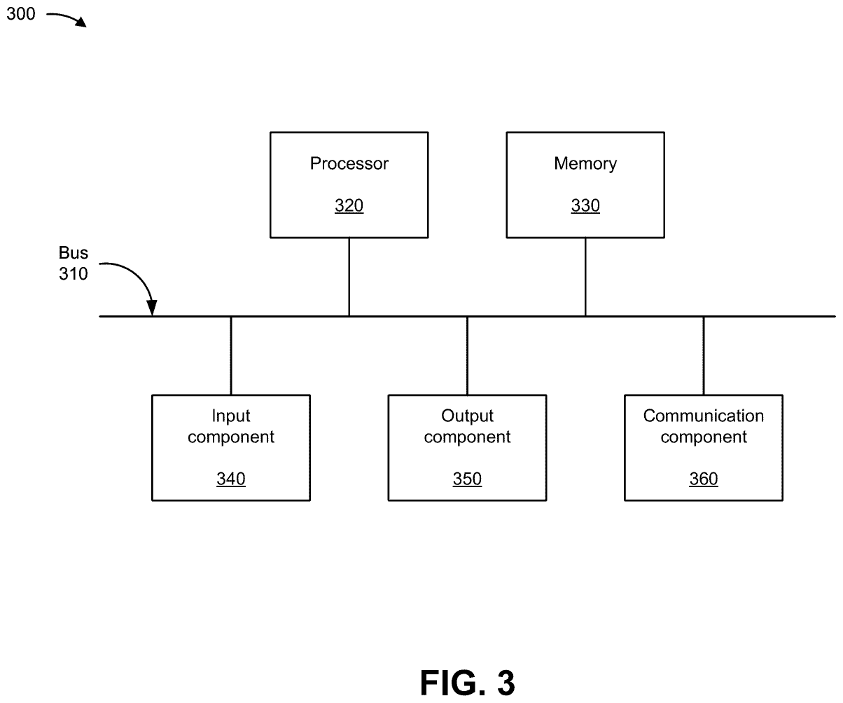

Although the coverage detection system 106 may include one or more elements 203-213 of the cloud computing system 202, may execute within the cloud computing system 202, and/or may be hosted within the cloud computing system 202, in some implementations, the coverage detection system 106 may not be cloud-based (e.g., may be implemented outside of a cloud computing system) or may be partially cloud-based. For example, the coverage detection system 106 may include one or more devices that are not part of the cloud computing system 202, such as the device 300 of FIG. 3, which may include a standalone server or another type of computing device. The coverage detection system 106 may perform one or more operations and/or processes described in more detail elsewhere herein.

The network 220 may include one or more wired and/or wireless networks. For example, the network 220 may include a cellular network (e.g., a 5G network, a 4G network, an LTE network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 220 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the FWA CPE 102, the base station 104, and/or the coverage detection system 106. In some implementations, the FWA CPE 102, the base station 104, and/or the coverage detection system 106 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

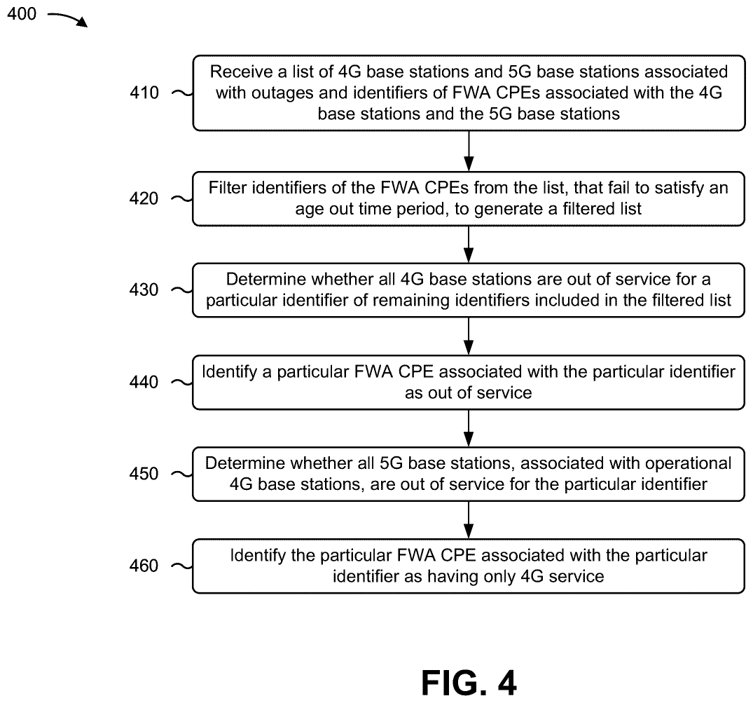

FIG. 4 is a flowchart of an example process 400 for detecting FWA CPE coverage during a planned network outage. In some implementations, one or more process blocks of FIG. 4 may be performed by a device (e.g., the coverage detection system 106). In some implementations, one or more process blocks of FIG. 4 may be performed by another device or a group of devices separate from or including the device, such as an FWA CPE (e.g., the FWA CPE 102) and/or a base station (e.g., the base station 104). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a list of 4G base stations and 5G base stations associated with outages and identifiers of FWA CPEs associated with the 4G base stations and the 5G base stations (block 410). For example, the device may receive a list of 4G base stations and 5G base stations associated with outages and identifiers of FWA CPEs associated with the 4G base stations and the 5G base stations, as described above.

As further shown in FIG. 4, process 400 may include filtering identifiers of the FWA CPEs from the list, that fail to satisfy an age out time period, to generate a filtered list (block 420). For example, the device may filter identifiers of the FWA CPEs from the list that fail to satisfy an age out time period in order to generate a filtered list, as described above. In some implementations, the age out time period is three months.

As further shown in FIG. 4, process 400 may include determining whether all 4G base stations are out of service for a particular identifier of remaining identifiers included in the filtered list (block 430). For example, the device may determine whether all 4G base stations are out of service for a particular identifier of remaining identifiers included in the filtered list, as described above.

As further shown in FIG. 4, process 400 may include identifying a particular FWA CPE associated with the particular identifier as out of service (block 440). For example, the device may identify a particular FWA CPE associated with the particular identifier as out of service based on determining that all 4G base stations are out of service for the particular identifier, as described above. In some implementations, the particular identifier of the particular FWA CPE is an MDN of the particular FWA CPE.

As further shown in FIG. 4, process 400 may include determining whether all 5G base stations, associated with operational 4G base stations, are out of service for the particular identifier (block 450). For example, the device may determine whether all 5G base stations, associated with operational 4G base stations, are out of service for the particular identifier based on determining that not all 4G base stations are out of service for the particular identifier, as described above.

As further shown in FIG. 4, process 400 may include identifying the particular FWA CPE associated with the particular identifier as having only 4G service (block 460). For example, the device may identify the particular FWA CPE associated with the particular identifier as having only 4G service based on determining that all 5G base stations, associated with operational 4G base stations, are out of service for the particular identifier, as described above.

In some implementations, process 400 includes identifying the particular FWA CPE associated with the particular identifier as having 4G and 5G service based on determining that not all 5G base stations, associated with operational 4G base stations, are out of service for the particular identifier.

In some implementations, process 400 includes receiving another list of primary and secondary 5G base stations associated with outages and other identifiers of other FWA CPEs associated with the primary and secondary 5G base stations; filtering identifiers of the other FWA CPEs from the other list, that fail to satisfy the age out time period, to generate another filtered list; determining whether all primary 5G base stations are out of service for another particular identifier of remaining identifiers included in the other filtered list; identifying another particular FWA CPE associated with the other particular identifier as out of service based on determining that all primary 5G base stations are out of service for the other particular identifier; determining whether all secondary 5G base stations, associated with operational primary 5G base stations, are out of service for the other particular identifier based on determining that not all primary 5G base stations are out of service for the other particular identifier; and identifying the other particular FWA CPE associated with the other particular identifier as having only primary 5G service based on determining that all secondary 5G base stations, associated with operational primary 5G base stations, are out of service for the other particular identifier.

In some implementations, process 400 includes identifying the other particular FWA CPE associated with the other particular identifier as having primary and secondary 5G service based on determining that not all secondary 5G base stations, associated with operational primary 5G base stations, are out of service for the other particular identifier.

In some implementations, process 400 includes receiving a service address of the other particular FWA CPE, a location of a particular primary 5G base station, and an identifier of a particular secondary 5G base station and anchored to the particular primary 5G base station; determining whether the service address is in a coverage area of the particular primary 5G base station based on comparing the service address and the location; determining that the particular FWA CPE has moved based on the service address not being in the coverage area of the particular primary 5G base station; copying the particular identifier of the particular FWA CPE to a move database based on the service address not being in the coverage area of the particular primary 5G base station; copying a connection history of the particular FWA CPE to an address connection database based on the service address not being in the coverage area of the particular primary 5G base station; and deleting an entry for the particular FWA CPE from an identifier connection database based on the service address not being in the coverage area of the particular primary 5G base station.

In some implementations, process 400 includes receiving a service address of the particular FWA CPE, a location of a particular 4G base station of the 4G base stations, and an identifier of a particular 5G base station of the 5G base stations and anchored to the particular 4G base station; determining whether the service address is in a coverage area of the particular 4G base station based on comparing the service address and the location; determining that the particular FWA CPE has moved based on the service address not being in the coverage area of the particular 4G base station; copying the particular identifier of the particular FWA CPE to a move database based on the service address not being in the coverage area of the particular 4G base station; copying a connection history of the particular FWA CPE to an address connection database based on the service address not being in the coverage area of the particular 4G base station; and deleting an entry for the particular FWA CPE from an identifier connection database based on the service address not being in the coverage area of the particular 4G base station.

In some implementations, process 400 includes utilizing the particular identifier of the particular FWA CPE from the move database to identify customer information, receiving an updated service address based on the customer information, and providing the updated service address in an account database.

In some implementations, process 400 includes receiving a service address of the particular FWA CPE, a location of a particular 4G base station of the 4G base stations, and an identifier of a particular 5G base station of the 5G base stations and anchored to the particular 4G base station; determining whether the service address is in a coverage area of the particular 4G base station based on comparing the service address and the location; determining whether the particular identifier of the particular FWA CPE is in an identifier connection database based on the service address being in the coverage area of the particular 4G base station; determining whether an identifier of the particular 4G base station is in the identifier connection database based on determining that the particular identifier of the particular FWA CPE is in the identifier connection database; adding the identifier of the particular 4G base station to the identifier connection database based on determining that the identifier of the particular 4G base station is not in the identifier connection database; and updating the identifier of the particular 4G base station with a latest connection time.

In some implementations, process 400 includes determining whether the particular identifier of the particular FWA CPE is in an address connection database based on determining that the particular identifier of the particular FWA CPE is not in the identifier connection database, and copying an entry for the particular FWA CPE from the address connection database to the identifier connection database based on determining that the particular identifier of the particular FWA CPE is in the address connection database.

In some implementations, process 400 includes determining whether the identifier of the particular 5G base station is in the identifier connection database, and adding the identifier of the particular 5G base station under the identifier of the particular 4G base station in the identifier connection database based on determining that the identifier of the particular 5G base station is not in the identifier connection database.

In some implementations, process 400 includes updating the identifier of the particular 5G base station with a latest connection time in the identifier connection database based on determining that the identifier of the particular 5G base station is in the identifier connection database.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a list of fourth-generation (4G) base stations and fifth-generation (5G) base stations associated with outages and identifiers of fixed wireless access (FWA) customer premise equipment (CPEs) associated with the 4G base stations and the 5G base stations;
filtering, by the device, identifiers of the FWA CPEs from the list, that fail to satisfy an age out time period, to generate a filtered list;
determining, by the device, whether all 4G base stations are out of service for a particular identifier of remaining identifiers included in the filtered list;
identifying, by the device, a particular FWA CPE associated with the particular identifier as out of service based on determining that all 4G base stations are out of service for the particular identifier;
determining, by the device, whether all 5G base stations, associated with operational 4G base stations, are out of service for the particular identifier based on determining that not all 4G base stations are out of service for the particular identifier; and
identifying, by the device, the particular FWA CPE associated with the particular identifier as having only 4G service based on determining that all 5G base stations, associated with operational 4G base stations, are out of service for the particular identifier.

2. The method of claim 1, further comprising:
identifying the particular FWA CPE associated with the particular identifier as having 4G and 5G service based on determining that not all 5G base stations, associated with operational 4G base stations, are out of service for the particular identifier.

3. The method of claim 1, further comprising:
receiving another list of primary and secondary 5G base stations associated with outages and other identifiers of other FWA CPEs associated with the primary and secondary 5G base stations;
filtering identifiers of the other FWA CPEs from the other list, that fail to satisfy the age out time period, to generate another filtered list;
determining whether all primary 5G base stations are out of service for another particular identifier of remaining identifiers included in the other filtered list;
identifying another particular FWA CPE associated with the other particular identifier as out of service based on determining that all primary 5G base stations are out of service for the other particular identifier;
determining whether all secondary 5G base stations, associated with operational primary 5G base stations, are out of service for the other particular identifier based on determining that not all primary 5G base stations are out of service for the other particular identifier; and
identifying the other particular FWA CPE associated with the other particular identifier as having only primary 5G service based on determining that all secondary 5G base stations, associated with operational primary 5G base stations, are out of service for the other particular identifier.

4. The method of claim 3, further comprising:
identifying the other particular FWA CPE associated with the other particular identifier as having primary and secondary 5G service based on determining that not all secondary 5G base stations, associated with operational primary 5G base stations, are out of service for the other particular identifier.

5. The method of claim 1, further comprising:
receiving a service address of the other particular FWA CPE, a location of a particular primary 5G base station, and an identifier of a particular secondary 5G base station and anchored to the particular primary 5G base station;
determining whether the service address is in a coverage area of the particular primary 5G base station based on comparing the service address and the location;
determining that the particular FWA CPE has moved based on the service address not being in the coverage area of the particular primary 5G base station;
copying the particular identifier of the particular FWA CPE to a move database based on the service address not being in the coverage area of the particular primary 5G base station;
copying a connection history of the particular FWA CPE to an address connection database based on the service address not being in the coverage area of the particular primary 5G base station; and
deleting an entry for the particular FWA CPE from an identifier connection database based on the service address not being in the coverage area of the particular primary 5G base station.

6. The method of claim 1, further comprising:
receiving a service address of the particular FWA CPE, a location of a particular 4G base station of the 4G base stations, and an identifier of a particular 5G base station of the 5G base stations and anchored to the particular 4G base station;
determining whether the service address is in a coverage area of the particular 4G base station based on comparing the service address and the location;
determining that the particular FWA CPE has moved based on the service address not being in the coverage area of the particular 4G base station;
copying the particular identifier of the particular FWA CPE to a move database based on the service address not being in the coverage area of the particular 4G base station;
copying a connection history of the particular FWA CPE to an address connection database based on the service address not being in the coverage area of the particular 4G base station; and
deleting an entry for the particular FWA CPE from an identifier connection database based on the service address not being in the coverage area of the particular 4G base station.

7. The method of claim 6, further comprising:
utilizing the particular identifier of the particular FWA CPE from the move database to identify customer information;
receiving an updated service address based on the customer information; and
providing the updated service address in an account database.

8. A device, comprising:
one or more memories; and
one or more processors, coupled to the one or more memories, configured to:
receive a list of fourth-generation (4G) base stations and fifth-generation (5G) base stations associated with outages and identifiers of fixed wireless access (FWA) customer premise equipment (CPEs) associated with the 4G base stations and the 5G base stations;
filter identifiers of the FWA CPEs from the list, that fail to satisfy an age out time period, to generate a filtered list;
determine whether all 4G base stations are out of service for a particular identifier of remaining identifiers included in the filtered list;
identify a particular FWA CPE associated with the particular identifier as out of service based on determining that all 4G base stations are out of service for the particular identifier;
determine whether all 5G base stations, associated with operational 4G base stations, are out of service for the particular identifier based on determining that not all 4G base stations are out of service for the particular identifier;
identify the particular FWA CPE associated with the particular identifier as having only 4G service based on determining that all 5G base stations, associated with operational 4G base stations, are out of service for the particular identifier; and
identify the particular FWA CPE associated with the particular identifier as having 4G and 5G service based on determining that not all 5G base stations, associated with operational 4G base stations, are out of service for the particular identifier.

9. The device of claim 8, wherein the particular identifier of the particular FWA CPE is a mobile directory number of the particular FWA CPE.

10. The device of claim 8, wherein the one or more processors are further configured to:
receive a service address of the particular FWA CPE, a location of a particular 4G base station of the 4G base stations, and an identifier of a particular 5G base station of the 5G base stations and anchored to the particular 4G base station;
determine whether the service address is in a coverage area of the particular 4G base station based on comparing the service address and the location;
determine whether the particular identifier of the particular FWA CPE is in an identifier connection database based on the service address being in the coverage area of the particular 4G base station;
determine whether an identifier of the particular 4G base station is in the identifier connection database based on determining that the particular identifier of the particular FWA CPE is in the identifier connection database;
add the identifier of the particular 4G base station to the identifier connection database based on determining that the identifier of the particular 4G base station is not in the identifier connection database; and
update the identifier of the particular 4G base station with a latest connection time.

11. The device of claim 10, wherein the one or more processors are further configured to:
determine whether the particular identifier of the particular FWA CPE is in an address connection database based on determining that the particular identifier of the particular FWA CPE is not in the identifier connection database; and
copy an entry for the particular FWA CPE from the address connection database to the identifier connection database based on determining that the particular identifier of the particular FWA CPE is in the address connection database.

12. The device of claim 10, wherein the one or more processors are further configured to:
determine whether the identifier of the particular 5G base station is in the identifier connection database; and
add the identifier of the particular 5G base station under the identifier of the particular 4G base station in the identifier connection database based on determining that the identifier of the particular 5G base station is not in the identifier connection database.

13. The device of claim 12, wherein the one or more processors are further configured to:
update the identifier of the particular 5G base station with a latest connection time in the identifier connection database based on determining that the identifier of the particular 5G base station is in the identifier connection database.

14. The device of claim 8, wherein the age out time period is three months.

15. A non-transitory computer-readable medium storing a set of instructions, the set of instructions comprising:
one or more instructions that, when executed by one or more processors of a device, cause the device to:
receive a list of fourth-generation (4G) base stations and fifth-generation (5G) base stations associated with outages and identifiers of fixed wireless access (FWA) customer premise equipment (CPEs) associated with the 4G base stations and the 5G base stations;
filter identifiers of the FWA CPEs from the list, that fail to satisfy an age out time period, to generate a filtered list;
determine whether all 4G base stations are out of service for a particular identifier of remaining identifiers included in the filtered list;
identify a particular FWA CPE associated with the particular identifier as out of service based on determining that all 4G base stations are out of service for the particular identifier;
determine whether all 5G base stations, associated with operational 4G base stations, are out of service for the particular identifier based on determining that not all 4G base stations are out of service for the particular identifier;
identify the particular FWA CPE associated with the particular identifier as having only 4G service based on determining that all 5G base stations, associated with operational 4G base stations, are out of service for the particular identifier; and
identify the particular FWA CPE associated with the particular identifier as having 4G and 5G service based on determining that not all 5G base stations, associated with operational 4G base stations, are out of service for the particular identifier.

16. The non-transitory computer-readable medium of claim 15, wherein the one or more instructions further cause the device to:
receive another list of primary and secondary 5G base stations associated with outages and other identifiers of other FWA CPEs associated with the primary and secondary 5G base stations;
filter identifiers of the other FWA CPEs from the other list, that fail to satisfy the age out time period, to generate another filtered list;
determine whether all primary 5G base stations are out of service for another particular identifier of remaining identifiers included in the other filtered list;
identify another particular FWA CPE associated with the other particular identifier as out of service based on determining that all primary 5G base stations are out of service for the other particular identifier;
determine whether all secondary 5G base stations, associated with operational primary 5G base stations, are out of service for the other particular identifier based on determining that not all primary 5G base stations are out of service for the other particular identifier; and
identify the other particular FWA CPE associated with the other particular identifier as having only primary 5G service based on determining that all secondary 5G base stations, associated with operational primary 5G base stations, are out of service for the other particular identifier; and
identify the other particular FWA CPE associated with the other particular identifier as having primary and secondary 5G service based on determining that not all secondary 5G base stations, associated with operational primary 5G base stations, are out of service for the other particular identifier.

17. The non-transitory computer-readable medium of claim 15, wherein the one or more instructions further cause the device to:
receive a service address of the other particular FWA CPE, a location of a particular primary 5G base station, and an identifier of a particular secondary 5G base station and anchored to the particular primary 5G base station;
determine whether the service address is in a coverage area of the particular primary 5G base station based on comparing the service address and the location;
determine that the particular FWA CPE has moved based on the service address not being in the coverage area of the particular primary 5G base station;
copy the particular identifier of the particular FWA CPE to a move database based on the service address not being in the coverage area of the particular primary 5G base station;
copy a connection history of the particular FWA CPE to an address connection database based on the service address not being in the coverage area of the particular primary 5G base station; and
delete an entry for the particular FWA CPE from an identifier connection database based on the service address not being in the coverage area of the particular primary 5G base station.

18. The non-transitory computer-readable medium of claim 15, wherein the one or more instructions further cause the device to:
receive a service address of the particular FWA CPE, a location of a particular 4G base station of the 4G base stations, and an identifier of a particular 5G base station of the 5G base stations and anchored to the particular 4G base station;
determine whether the service address is in a coverage area of the particular 4G base station based on comparing the service address and the location;
determine that the particular FWA CPE has moved based on the service address not being in the coverage area of the particular 4G base station;
copy the particular identifier of the particular FWA CPE to a move database based on the service address not being in the coverage area of the particular 4G base station;
copy a connection history of the particular FWA CPE to an address connection database based on the service address not being in the coverage area of the particular 4G base station; and
delete an entry for the particular FWA CPE from an identifier connection database based on the service address not being in the coverage area of the particular 4G base station.

19. The non-transitory computer-readable medium of claim 18, wherein the one or more instructions further cause the device to:
utilize the particular identifier of the particular FWA CPE from the move database to identify customer information;
receive an updated service address based on the customer information; and
provide the updated service address in an account database.

20. The non-transitory computer-readable medium of claim 15, wherein the one or more instructions further cause the device to:
receive a service address of the particular FWA CPE, a location of a particular 4G base station of the 4G base stations, and an identifier of a particular 5G base station of the 5G base stations and anchored to the particular 4G base station;
determine whether the service address is in a coverage area of the particular 4G base station based on comparing the service address and the location;
determine whether the particular identifier of the particular FWA CPE is in an identifier connection database based on the service address being in the coverage area of the particular 4G base station;
determine whether an identifier of the particular 4G base station is in the identifier connection database based on determining that the particular identifier of the particular FWA CPE is in the identifier connection database;
add the identifier of the particular 4G base station to the identifier connection database based on determining that the identifier of the particular 4G base station is not in the identifier connection database; and
update the identifier of the particular 4G base station with a latest connection time.
